(19) United States
(12) Patent Application Publication
(10) Pub. No.: US 2025/0287870 A1
(43) Pub. Date: Sep. 18, 2025

(54) MOWER

(71) Applicant: HONDA MOTOR CO., LTD., Tokyo (JP)

(72) Inventors: Keisuke Matsubara, Wako-shi (JP); Rina Akune, Wako-shi (JP); Yuko Nishi, Wako-shi (JP); Fumio Minami, Wako-shi (JP); Tatsuya Yamazaki, Wako-shi (JP)

(21) Appl. No.: 18/604,997

(22) Filed: Mar. 14, 2024

(51) Int. Cl. A01D 34/81; A01D 34/66; A01D 101/00

(52) U.S. Cl. CPC A01D 34/81; A01D 34/66; A01D 2101/00

(57) ABSTRACT

A mower includes: a plurality of wheels; at least one cutter blade that cuts turfgrass; and a blade accommodating section that accommodates the cutter blade, in which the blade accommodating section includes an upper wall section and a peripheral wall section, the peripheral wall section has an inside accommodating three or more of the cutter blades side by side, the cutter blades rotating in the same direction, a partition member is provided between the two cutter blades accommodated in one end side of the upper wall section, and the partition member is not provided between the cutter blades accommodated in the other end side of the upper wall section.

### BACKGROUND OF THE INVENTION

### Field of the Invention

The present invention relates to a mower.

### Description of the Related Art

In recent years, efforts for realizing a low-carbon or decarbonized society have become more active, and also for lawn mowers, research and development on electrification technology has been conducted in order to reduce CO2 emissions and improve energy efficiency.

Japanese Patent Laid-Open No. 2007-89498 discloses a lawn mower that includes: at least one cutter blade that cuts turfgrass; and a blade accommodating section that accommodates the cutter blade, in which the blade accommodating section accommodates three cutter blades and has partitions each provided between cutter blades.

However, in Patent Literature 1, since presence of partitions each between the cutter blades does not allow the cut grass to move inside the blade accommodating section, there is a disadvantage in which the three cutter blades cannot be effectively used to cut the turfgrass finely and efficiently.

Therefore, the present disclosure provides a lawn mower capable of cutting turfgrass more efficiently.

### SUMMARY OF THE INVENTION

An aspect of the present invention is a lawn mower including: a plurality of wheels; at least one cutter blade that cuts turfgrass; and a blade accommodating section that accommodates the cutter blade, in which the blade accommodating section includes an upper wall section and a peripheral wall section, and the peripheral wall section has an inside accommodating three or more of the cutter blades side by side, the cutter blades rotating in the same direction, a partition member is provided between the two cutter blades accommodated in one end side of the upper wall section, and the partition member is not provided between the cutter blades accommodated in the other end side of the upper wall section.

According to the present disclosure, turfgrass can be cut more efficiently.

### BRIEF DESCRIPTION OF THE DRAWINGS

FIG. 1 is a perspective view of a lawn mower according to one embodiment;

FIG. 2 is a bottom view of the lawn mower;

FIG. 3 is a bottom view of a blade accommodating section;

FIG. 4 is a perspective view of a lower surface of the blade accommodating section;

FIG. 5 is a perspective view of the lower surface of the blade accommodating section;

FIG. 6 is a cross sectional view taken along VI-VI in FIG. 3;

FIG. 7 is a cross sectional view taken along VII-VII in FIG. 3;

FIG. 8 is a bottom view of the blade accommodating section;

FIG. 9 is a diagram showing a state in which turfgrass stays on a grass catch member; and

FIG. 10 is an explanatory diagrams comparing and describing a case without the grass catch member and a case with the grass catch member.

### DETAILED DESCRIPTION OF THE PREFERRED EMBODIMENT

### Lawn Mower Configuration

Hereinafter, a lawn mower according to one embodiment will be described.

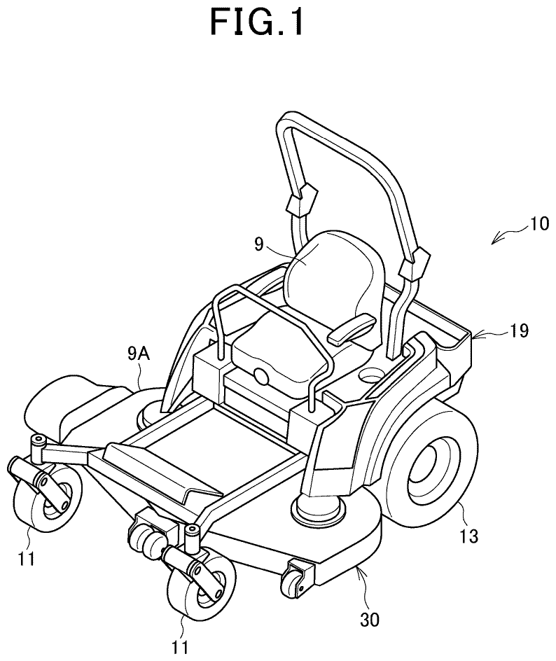

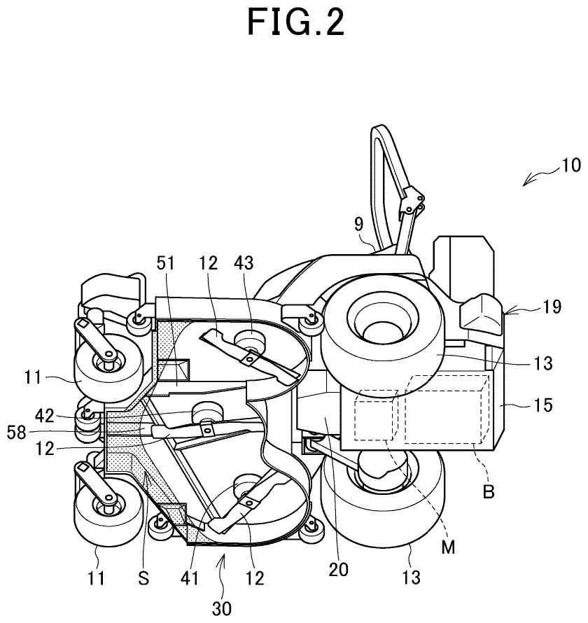

FIG. 1 is a perspective view showing a lawn mower 10 according to one embodiment. FIG. 2 is a bottom view of the lawn mower 10. In FIG. 2, a grass dropping space S is shown with dots.

The lawn mower 10 includes a driver's seat 9 on which a driver sits, and is a riding lawn mower. The lawn mower 10 includes a body frame 19, two front wheels 11, and two rear wheels 13, and is provided with a blade accommodating section 30 between the front wheels 11 and the rear wheels 13.

The blade accommodating section 30 accommodates three cutter blades 12 for cutting turfgrass. The blade accommodating section 30 is disposed below a step 9A of the driver's seat 9. The number of wheels 11 and 13 is not limited to four.

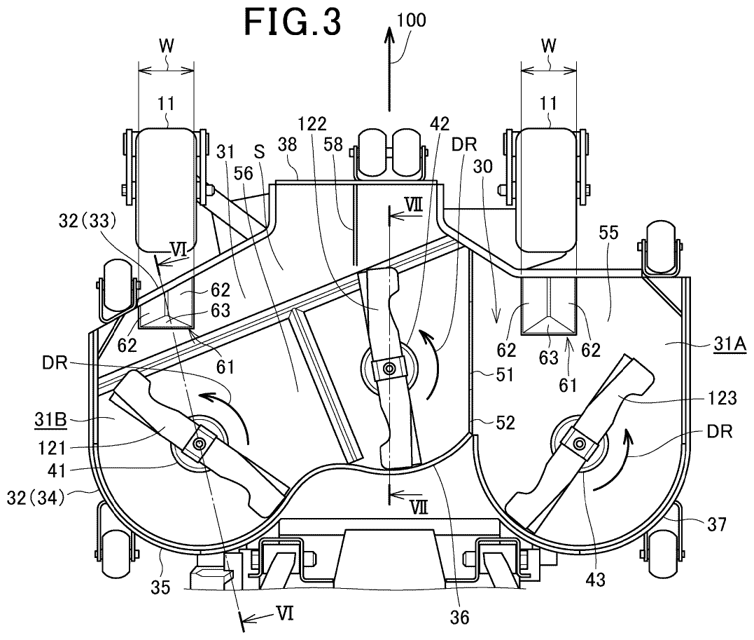

FIG. 3 is a view of the blade accommodating section 30 viewed from below.

As shown in FIG. 3, the three cutter blades 12 include, in order from the right side of the vehicle body (left side in the figure), a first cutter blade 121, a second cutter blade 122, and a third cutter blade 123. The three cutter blades 12 rotate in the same direction (counterclockwise in the figure). The number of cutter blades 12 is not limited to three. As shown in FIG. 2, the two rear wheels 13 are driven by a traveling motor M. The traveling motor M is a first motor. A battery box 15 is disposed between the two rear wheels 13. A battery B, which serves as a drive source for the traveling motor M, is disposed in the battery box 15. The drive source of the traveling motor M may be an internal combustion engine.

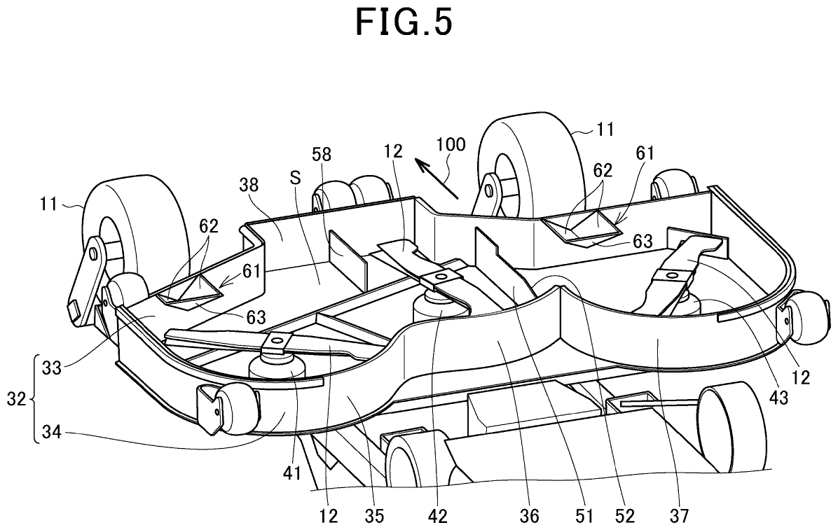

As shown in FIGS. 3 to 5, the blade accommodating section 30 includes an upper wall section 31 and a peripheral wall section 32 that hangs downward from the outer peripheral edge of the upper wall section 31. The peripheral wall section 32 is not limited to being in a form of hanging downward from the upper wall section 31, but may also be in a form of extending downward from the upper wall section 31 or in a form of narrowing downward therefrom. The peripheral wall section 32 includes a front-half peripheral wall 33 and a rear-half peripheral wall 34. The peripheral wall section 32 is formed into an annular shape by the front-half peripheral wall 33 and the rear-half peripheral wall 34, but is not limited to this, and may have a part of the front-half peripheral wall 33 that is open or a part of the rear-half peripheral wall 34 that is open.

The rear-half peripheral wall 34 is formed by three circular arc sections 35, 36, and 37 that are continuous along the rotation paths of the three cutter blades 12. The front-half peripheral wall 33 is formed to be spaced apart from the rotation paths of the three cutter blades 12 by predetermined intervals, so as to form a grass dropping space S shown in FIG. 2 in front of the rotation paths of the three cutter blades 12. The front-half peripheral wall 33 includes a rectangular peripheral wall 38, projecting in a rectangular shape, at the frontmost end part. Providing the rectangular peripheral wall 38 expands the grass dropping space S, and therefore enables the cut grass to be discharged further forward.

The blade accommodating section 30 covers a predetermined area around the cutter blades 12, and thereby can limit the scattering area of the cut grass.

The cut grass is pieces of turfgrass cut by the cutter blades 12. The shape of the blade accommodating section 30 in a top view or in a bottom view is not limited to the form shown in FIGS. 3 to 5. In the present embodiment, the upper wall section 31 and the peripheral wall section 32 are configured as separate members, but are not limited to this, and the upper wall section 31 and the peripheral wall section 32 may be integrally formed.

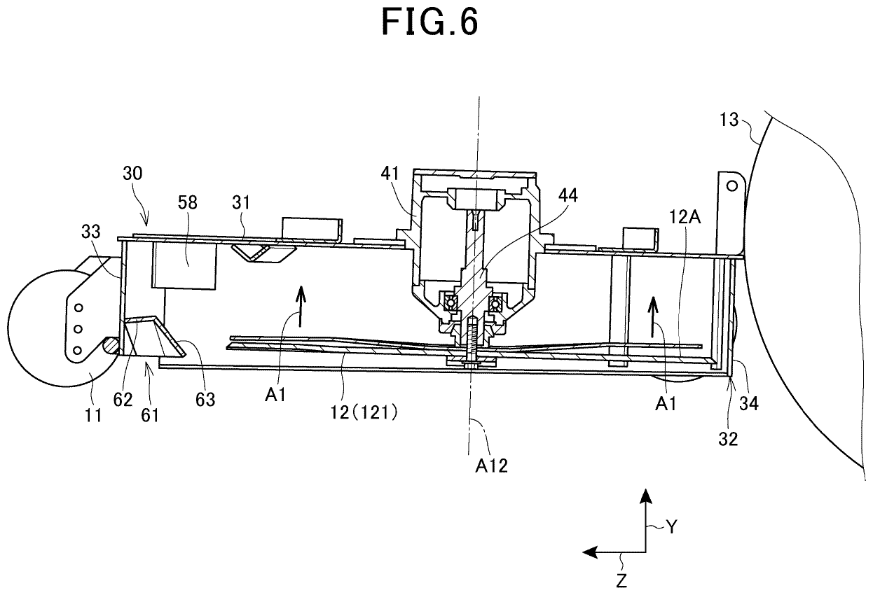

FIG. 6 is a cross sectional view taken along VI-VI in FIG. 3.

The upper wall section 31 is provided with a first cutter motor 41 that rotates the first cutter blade 121. A second cutter motor 42 that rotates the second cutter blade 122 and a third cutter motor 43 that rotates the third cutter blade 123 are installed in the same manner as the first cutter motor 41, so their description will be omitted.

The first cutter motor 41 is installed so as to penetrate the upper wall section 31, and has a motor shaft 44 to which the first cutter blade 121 is attached. The upper wall section 31 is located above the cutter blades 12. The first cutter motor 41, the second cutter motor 42, and the third cutter motor 43 are second motors for rotating the cutter blades 12, and have the battery B serving as a drive source.

The number of blades included in the cutter blades 12 may be one or more. The cutter blades 12 are provided at the lower part of the lawn mower 10. The lawn mower 10 of the present embodiment is a rotary lawn mower. Therefore, cutter blades 12 are rotary blades. The cutter blades 12 rotate in accordance with the drive of the cutter motors 41 to 43. As a result, the turfgrass growing on the running surface of the lawn mower 10 is cut by the cutter blades 12. In the present embodiment, lawn mower 10 is a rotary lawn mower, but is not limited to this.

The rotation axis A12 of each cutter blade 12 extends in the up-down direction Y of the lawn mower 10. The up-down direction Y is a direction that intersects the front-rear direction Z. The up-down direction Y and the front-rear direction Z are perpendicular to each other.

The rotation direction DR of the cutter blade 12 (see FIG. 3) is determined in advance based on the direction of the blade of the cutter blade 12. Therefore, the rotation direction DR of the cutter blade 12 is not limited to the direction of the arrow shown in FIG. 3.

The cutter blade 12 has a wing section 12A. The wing section 12A generates an upward airflow Al according to the rotation of the cutter blade 12.

The airflow A1 causes the head end part of the turfgrass growing on the running surface of the lawn mower 10 to stand up vertically. This makes it easier for turfgrass to come into contact with the rotating cutter blade 12. In other words, the turfgrass is cut by the cutter blade 12 more easily.

As shown in FIG. 2, the lawn mower 10 includes a control section 20. The control section 20 is a computer that controls the lawn mower 10.

The control section 20 includes, for example, a processor and a memory. The memory stores computer executable programs. The processor executes programs stored in the memory. The control section 20 can drive the cutter blades 12 and wheels 11 and 13 based on the programs. At least a part of the control section 20 may be configured by an integrated circuit, a discrete device, or the like.

### Configuration of Partition Member

FIGS. 3 to 5 are detailed views of the blade accommodating section 30.

The three cutter blades 12 are accommodated inside the peripheral wall section 32 of the blade accommodating section 30 so as to be in line from one end 31A of the upper wall section 31 to the other end 31B thereof. The three cutter blades 12 each rotate in the direction DR (see FIG. 3) from one end 31A toward the other end 31B. In FIG. 3, the three cutter blades 12 rotate counterclockwise.

A second cutter blade 122 and a third cutter blade 123 are accommodated in the one end 31A side of the blade accommodating section 30.

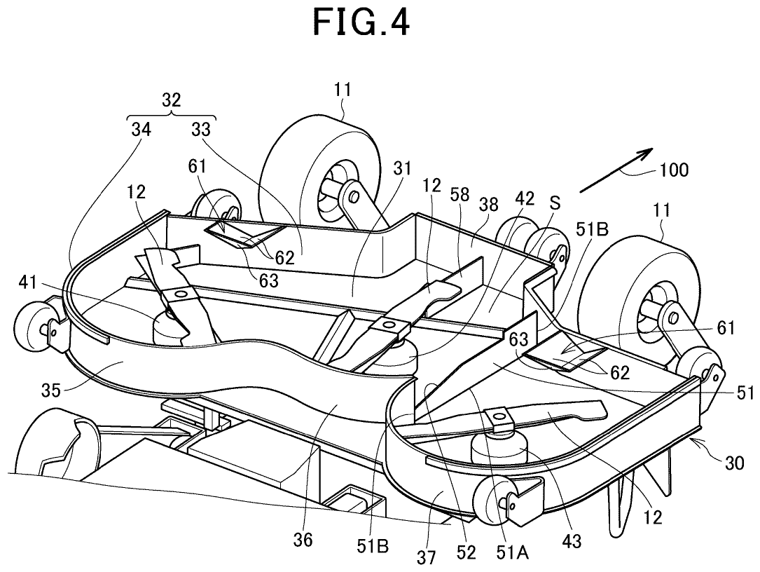

A partition member 51 is provided between the two cutter blades 122 and 123, as shown in FIGS. 3 to 5. As shown in FIG. 4, the partition member 51 has an upper edge part 51A fixed to the lower surface of the upper wall section 31 by welding, and opposing end parts 51B respectively fixed to the opposing wall surfaces of the peripheral wall section 32 by welding. Since the three cutter blades 12 rotate counterclockwise in FIG. 3, the cut turfgrass is likely to head toward the other end 31B of the blade accommodating section 30 and collect in the other end 31B side. The partition member 51 prevents the cut grass from moving to the other end 31B side and prevents the grass from accumulating in the other end 31B side.

A first cutter blade 121 and a second cutter blade 122 are accommodated in the other end 31B side of the blade accommodating section 30.

A partition member is not provided between the first cutter blade 121 and the second cutter blade 122. The blade accommodating section 30 is separated by one partition member 51, and one chamber 55 accommodates the third cutter blade 123 and the other chamber 56 accommodates the first cutter blade 121 and the second cutter blade 122 together.

Even if the cut turfgrass accumulates on the other end 31B, absence of the partition member between the first cutter blade 121 and the second cutter blade 122 allows the turfgrass to move to another room, so that fluidity of the turfgrass can be ensured.

As shown in FIG. 4, the partition member 51 is formed so as to be lower stepwise or gradually as progress rearward in the traveling direction of the lawn mower 10 (direction of arrow 100). This avoids interference between the partition member 51 and the two cutter blades 122 and 123. The rear end part of the partition member 51 is provided with a cutout 52 having the lowest height.

As shown in FIG. 3, the cutout 52 causes the one chamber 55 and the other chamber 56 to communicate. The cutout 52 causes the two cutter blades 122 and 123 accommodated in the one end 31A side to communicate. The cutout 52 is located further rear than half of the partition member 51.

This allows the two cutter blades 122 and 123 to communicate while separating one chamber 55 and the other chamber 56.

At least a part of the cutout 52 is located forward of the rotation center of the third cutter blade 123 located in the one end 31A side out of the second and third cutter blades 122 and 123 accommodated in the one end 31A side.

The partition member 51 is disposed near the cutter blade 122 located in the other end 31B side (substantially in the center of the blade accommodating section 30) out of the two second and third cutter blades 122 and 123 accommodated in the one end 31A side. A part of the partition member 51 is formed low not to overlap the rotation path of the second cutter blade 122 located substantially in the center of the blade accommodating section 30, which part would otherwise overlap the rotation path. This avoids interference between the partition member 51 and the second cutter blade 122.

An auxiliary partition member 58 is provided between the first and second cutter blades 121 and 122. The auxiliary partition member 58 is disposed so as not to overlap the rotation path of the second cutter blade 122. The rear end part of the auxiliary partition member 58 is located forward of the rotation center of at least one cutter blade (second cutter blade 122). The auxiliary partition member 58 suppresses the flow of grass from the second cutter blade 122 toward the first cutter blade 121, and suppresses the movement of the grass toward the other end 31B.

The upper edge part of the auxiliary partition member 58 is fixed to the lower surface of the upper wall section 31 by welding. The front end part of the auxiliary partition member 58 is fixed to the wall surface of the peripheral wall section 32 by welding. The front end part of the auxiliary partition member 58 is fixed to the wall surface of the rectangular peripheral wall 38 of the front-half peripheral wall 33 by welding. The rear end part of the auxiliary partition member 58 is not fixed to the peripheral wall section 32.

The auxiliary partition member 58 is fixed to the front-half peripheral wall 33 side, and is located in the grass dropping space S of the blade accommodating section 30, as shown in FIG. 2.

As shown in FIG. 3, in the present embodiment, a partition member 51 is provided between the second and third cutter blades 122 and 123 in the side opposite to the rotation direction of the cutter blades 12, and no partition member 51 is provided between the first and second cutter blades 121 and 122 in the same side as the rotation direction of the cutter blades 12. This can prevent the cut grass from moving toward the same side as the rotation direction of the cutter blades 12, and to prevent the grass from being unevenly distributed.

Generated uneven distribution of grass applies a higher load to the cutter blade 12 in the side where the more grass comes, but the present embodiment can prevent increase in load.

There is not the partition member 51 between the first and second cutter blades 121 and 122. Therefore, even if turfgrass accumulates in the same side as the rotation direction of the cutter blades 12, the turfgrass can be moved so as to escape to the opposite side, ensuring fluidity.

In the present embodiment, a part of the partition member 51 is formed slightly low, which part would otherwise overlap the cutter blade 12. This can prevent interference between the partition member 51 and the cutter blade 12. Furthermore, the partition member 51 is closer to the second cutter blade 122 than the third cutter blade 123. This can firmly prevent movement of the turfgrass of the third cutter blade 123.

In the present embodiment, the partition member 51 includes a cutout 52 in the rear in the traveling direction. It is desirable that the cutout 52 be located further rear than half of the partition member 51 in the traveling direction. As a result, the partition member 51 suppresses movement of turfgrass in the same direction as the rotation direction of the cutter blades 12 in the front side in the traveling direction, and facilitates movement of turfgrass in the direction opposite to the rotation direction of the cutter blades 12 in the rear side in the traveling direction. This can prevent turfgrass from accumulating in the rotation direction side of the cutter blades 12.

In the present embodiment, at least a part of the cutout 52 is located forward of the rotation center of the third cutter blade 123. As a result, the rotation direction of the third cutter blade 123 and the flow of the turfgrass are opposite to each other, and the turfgrass can be cut efficiently.

In the present embodiment, the partition member 51 is not provided between the first and second cutter blades 121 and 122, but an auxiliary partition member 58 is provided. According to this, the lawn mower 10 can further suppress the movement of turfgrass to the same side as the rotation direction of the cutter blade 12.

In the present embodiment, the rear end part of the auxiliary partition member 58 is located forward of the rotation center of at least one cutter blade 12. This secures a space without the auxiliary partition member 58, and allows the grass to be smoothly discharged.

### Configuration of Grass Catch Member

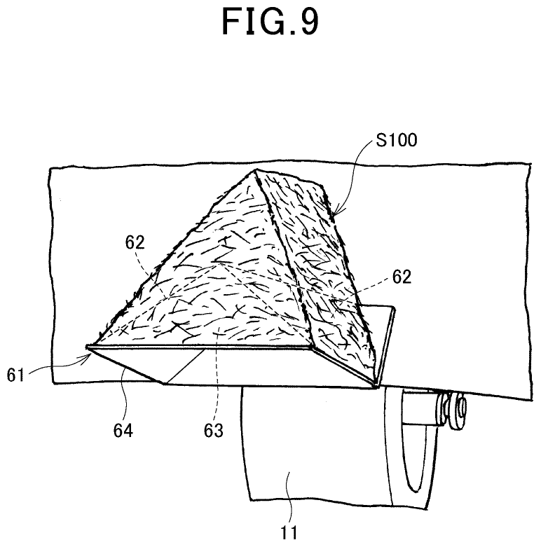

As shown in FIGS. 3 to 5, the blade accommodating section 30 includes two mountain-shaped grass catch members 61. The grass catch members 61 temporarily cause the turfgrass cut by the cutter blades 12 to stay on the mountain-shaped upper surface (see FIG. 9). The grass catch members 61 are attached to the front-half peripheral wall 33 of the peripheral wall section 32. The grass catch members 61 are located rearward of the front wheels 11 in the traveling direction of the lawn mower 10 and is attached to the wall surface of the front-half peripheral wall 33.

The width W of each grass catch member 61 is substantially the same as the width W of the front wheel 11, as shown in FIG. 3. It is desirable that the width W of the grass catch member 61 be the same as the width W of the front wheel 11 or wider than the width W of the front wheel 11. As shown in FIGS. 3 to 5, the mountain-shaped upper surface of the grass catch member 61 has lateral inclined surfaces 62 that are higher at the central part of the width W of the grass catch member 61 and are inclined downward from the central part toward the opposing sides. As shown in FIG. 3, the grass catch member 61 includes an end inclined surface 63 inclined downward at the rear end part in the traveling direction. The two grass catch members 61 are respectively paired with the first and third cutter blades 121 and 123. The clearance between the rotation path of the first cutter blade 121 and the grass catch member 61 is larger than the clearance between the rotation path of the third cutter blade 123 and the grass catch member 61. The grass catch members 61 are located within the grass dropping space S.

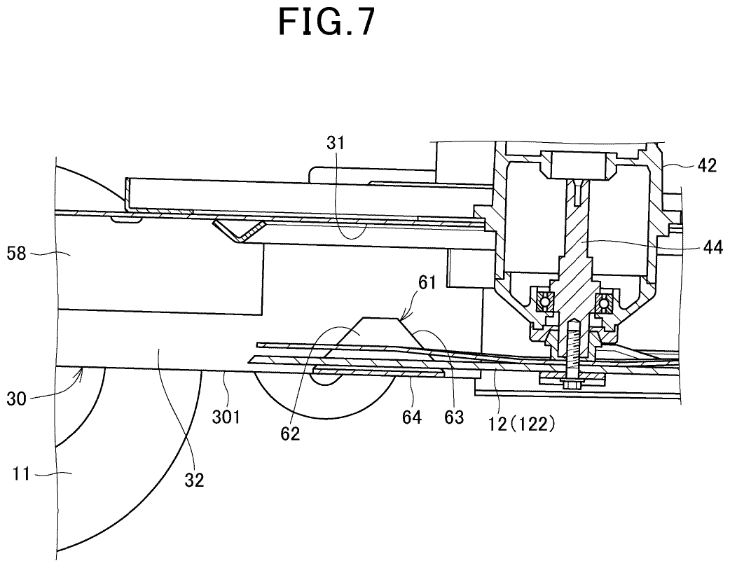

FIG. 7 is a cross sectional view taken along VII-VII in FIG. 3.

As shown in FIG. 7, the lower end 64 of each grass catch member 61 is at substantially the same height as the lower end 301 of the blade accommodating section 30. Alternatively, the lower end 64 of the grass catch member 61 is located at a slightly higher height than the lower end 301 of the blade accommodating section 30. The grass catch member 61 overlaps at least a part of the cutter blade 12 in a side view. The lower end 64 of the grass catch member 61 is located below the cutter blade 12.

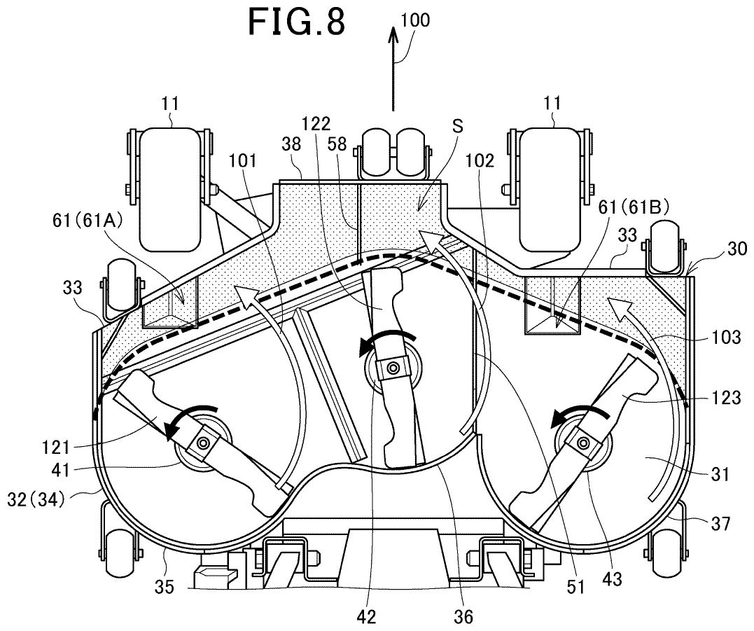

The function of the grass catch members 61 will be described with reference to FIGS. 8 to 10.

FIG. 8 is a bottom view of the blade accommodating section 30. In FIG. 8, the grass dropping space S is shown with dots.

In the lawn mower 10, rotation of the first to third cutter blades 121 to 123 moves the mowed lawn in the traveling direction 100. The first cutter blade 121 to the third cutter blade 123 cut the turfgrass growing on the running surface of the lawn mower 10. The cut turfgrass is moved within the blade accommodating section 30 as shown by arrows 101 to 103. The turfgrass reaches the grass dropping space S of the blade accommodating section 30 and falls onto the running surface. The functions of the partition member 51 and the auxiliary partition member 58 are as described above, and their description will be omitted.

A first grass catch member 61A is located forward of the first cutter blade 121 in the rotation direction 101, and a second grass catch member 61B is located forward of the third cutter blade 123 in the rotation direction 103. The first grass catch member 61A and the second grass catch member 61B indicate the grass catch members 61.

FIG. 9 is a diagram showing a state in which turfgrass S100 stays on the grass catch member.

As shown in FIG. 9, the turfgrass S100 cut away by the first cutter blade 121 temporarily remains on the upper surface of the first grass catch member 61A. The turfgrass S100 cut away by the third cutter blade 123 temporarily remains on the upper surface of the second grass catch member 61B. As described above, each of the upper surface of the first grass catch member 61A and the second grass catch member 61B includes the lateral inclined surfaces 62 and the end inclined surface 63. When the turfgrass remaining on each upper surface overflows, the turfgrass slides off the lateral inclined surfaces 62 and end inclined surface 63, and falls onto the running surface.

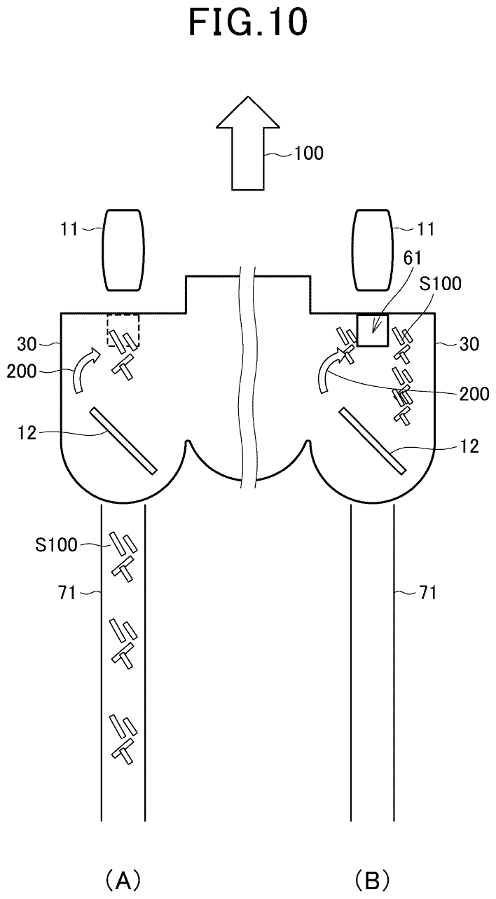

FIG. 10 is an explanatory diagram comparing and describing the case without the grass catch member 61 and the case with the grass catch member 61. Arrows 200 each indicate the direction of rotation of cutter blade 12. In FIG. 10, (A) shows the lawn mower 1 without the grass catch member 61, and (B) shows the lawn mower 1 with the grass catch member 61.

The lawn mower 10 according to the present embodiment employs a front-discharge system that discharges cut turfgrass S100 forward.

As shown in (A), it has been found that absence of the grass catch member 61 causes an event in which the turfgrass S100 having fallen into the ruts 71 of the front wheels 11 remains in the ruts 71 without being collected when the cutter blades 12 passes. When falling on the ruts 71, the turfgrass S100 does not fall into the grain of the turf and is left in lumps. The turfgrass S100 is left on the lawn stepped on by the front wheels 11 and the lawn stepped on cannot be mown, and it has been found that this causes occurrence of uncut grass, reduced mowing performance, poor finishing, and inferior landscape after work.

As shown in (B), when the grass catch members 61 are present, the grass catch members 61 are located rearward of the front wheels 11 in the traveling direction 100 of the lawn mower 10, and are attached to the wall surface of the front-half peripheral wall 33. A part of the cut turfgrass S100 remains on the upper surfaces of the grass catch members 61, falls outside the ruts 71 of the front wheels 11 when falling from the grass dropping space S, and is not left on the ruts 71.

In the present embodiment, the front-discharge lawn mower 10 includes grass catch members 61 rearward of the front wheels 11. This allows the cut turfgrass $100 to be stacked not on the grass that has fallen down by the front wheels 11, but on the grass that stands outside the ruts 71 of the front wheels 11. Therefore, when the cutter blade 12 passes, the turfgrass S100 can be cut again, and the turfgrass S100 can be reliably collected.

In the present embodiment, at least a part of each grass catch member 61 is located below the cutter blade 12. This causes the cut turfgrass S100 not to be blown away below the grass catch member 61. The grass catch member 61 includes lateral inclined surfaces 62 that are inclined respectively in the left and right directions of the lawn mower 10. This causes the turfgrass S100 to be less likely to accumulate on the upper surface of the grass catch member 61. The lower end 64 of the grass catch member 61 is located at the same height as the cutter blade 12 or above it. This can prevent the lower end 64 of the grass catch member 61 from being too low and causing the grass to lie flat before cut.

In the present embodiment, each grass catch member 61 overlaps at least a part of the cutter blade 12 in a side view. This causes the lawn mower 10 to be compact in the height direction.

In the present embodiment, there are two or more grass catch members 61, and the grass catch member 61 at the front in the rotation direction of the cutter blades 12 has a larger clearance from the cutter blade 12 than the grass catch member 61 at the rear in the rotation direction of the cutter blades 12. This can reduce the load of grass clogging. Furthermore, the end surface of the grass catch member 61 on the cutter blade 12 side is the end inclined surface 63. This causes the grass discharged from the cutter blade 12 to be more likely to scatter upward of the grass catch member 61.

The load applied to the cutter blade 12 is the resistance force that the cutter blade 12 receives from objects to be cut, such as turfgrass or cut grass when the object is cut. The load can increase as the amount of objects to be cut that stays in the blade accommodating section 30 increases. Reduction in the load on the cutter blade 12 can reduce the power consumption of the cutter motors 41, 42, and 43. This can reduce power consumption of the lawn mower 10.

The cutter motors 41, 42, and 43 are controlled by the control section 20. The control section 20 controls the cutter motors 41, 42, and 43 not to apply an excessive load to the cutter blade 12. The information indicating the load applied to the cutter blades 12 is, for example, the value of the current supplied to the cutter motors 41, 42, and 43, but is not limited to this. The value of the current supplied to the cutter motors 41, 42, and 43 is detected with a sensor such as a current sensor. The load on the cutter blade 12 when the turfgrass is wet is larger than the load on the cutter blade 12 when the turfgrass is dry.

The load applied to the cutter blades 12 increase as the turfgrass is longer. The load applied to the cutter blade 12 increases as the moving speed of the lawn mower 10 increases. Considering these, the control section 20 may control, for example, cutter motors 41, 42, and 43 based on information indicating at least one of the wetness of the turfgrass, the length of the turfgrass, the moving speed of the lawn mower 10, the weather, the temperature, and the humidity.

Information indicating at least one of the wetness of the turfgrass, the length of the turfgrass, the moving speed of the lawn mower 10, the weather, the temperature, and the humidity may be input into the control section 20 by the user, but is not limited to this. These pieces of information may be appropriately input to the control section 20 via a communication device provided in the lawn mower 10.

The wetness and humidity of the turfgrass may be detected by a humidity sensor. The temperature may be detected by a temperature sensor. The moving speed of the lawn mower 10 may be acquired by a speed sensor provided in the lawn mower 10. The length of the turfgrass may be detected by image recognition processing using an image of the turfgrass. The image of the turfgrass may be acquired by a camera included in the lawn mower 10, for example.

Each of the embodiments described above is not limited to this, and various modifications are possible.

The cutter motors 41, 42, and 43 are attached to the upper wall section 31 of the blade accommodating section 30, but are not limited to this. There may be a configuration such that the cutter motors 41, 42, and 43 are attached to the body frame 19 of the lawn mower 10, and each motor has a motor shaft 44, penetrating the upper wall section 31, that has a cutter blade 12 attached thereto within the blade accommodating section 30.

Unless otherwise specified, the directions and shapes such as horizontal and vertical in the embodiments described above include so-called equivalent ranges that provide the same effects as those directions and shapes.

### Configuration Supported by the Above Embodiment

The above embodiment supports the following configurations.

### Configuration 1

A mower including: a plurality of wheels; at least one cutter blade that cuts turfgrass; and a blade accommodating section that accommodates the cutter blade, in which the blade accommodating section includes an upper wall section and a peripheral wall section, and the peripheral wall section has an inside accommodating three or more of the cutter blades side by side, the cutter blades rotating in the same direction, a partition member is provided between the two cutter blades accommodated in one end side of the upper wall section, and the partition member is not provided between the cutter blades accommodated in the other end side of the upper wall section.

This prevents the grass from moving toward the same side as the rotation direction of the cutter blade accommodated in one end side, preventing uneven distribution of the grass. In addition, even if grass accumulates in the same side as the rotation direction of the cutter blades accommodated in the other end side, the grass can be moved so as to escape to the opposite side, allowing fluidity to be secured. Therefore, the cut grass can be moved within the blade accommodating section, and the cutter blade can be effectively used to cut the turfgrass finely.

### Configuration 2

The mower according to Configuration 1, in which the partition member includes a cutout in a rear end part in a traveling direction, the cutout causing the two cutter blades accommodated in the one end side to communicate.

This allows the cut grass to be efficiently moved within the blade accommodating section through the cutout of the partition member, allowing the turfgrass to be more efficiently cut.

### Configuration 3

The mower according to Configuration 2, in which the cutout is located further rear than half of the partition member.

This allows the cut grass to be efficiently moved within the blade accommodating section through the cutout of the partition member, allowing the turfgrass to be more efficiently cut.

### Configuration 4

The mower according to Configuration 2 or 3, in which at least a part of the cutout is located forward of a rotation center of the cutter blade located in the one end side out of the two cutter blades accommodated in the one end side.

This causes the flow of the grass to be opposite to the rotation direction of the cutter blades, allowing the turfgrass to be cut efficiently.

### Configuration 5

The mower according to any one of Configurations 1 to 4, in which the partition member is disposed near the cutter blade located in the other end side out of the two cutter blades accommodated in the one end side.

This allows the mower to firmly prevent movement of the grass of the cutter blades in the one end side.

### Configuration 6

The mower according to any one of Configurations 1 to 5, in which a part of the partition member is formed low not to overlap a rotation path of the cutter blade, the part of the partition member being to overlap the rotation path without being formed low.

This allows the mower to prevent interference between the partition member and the cutter blade.

### Configuration 7

The mower according to any one of Configurations 1 to 6, in which the blade accommodating section includes an upper wall section and a peripheral wall section, and an upper edge part of the partition member is fixed to a lower surface of the upper wall section, and opposing end parts of the partition member are respectively fixed to opposing wall surfaces of the peripheral wall section.

This allows the mower to have the partition member firmly fixed.

### Configuration 8

The mower according to any one of Configurations 1 to 7, further including an auxiliary partition member between the cutter blades accommodated in the other end side so as not to overlap rotation paths of the cutter blades.

This allows the mower to further suppress movement of the grass toward the same side as the rotation direction, and to prevent interference between the auxiliary partition member and the cutter blades.

### Configuration 9

The mower according to Configuration 8, in which a rear end part of the auxiliary partition member is located forward of a rotation center of the at least one cutter blade.

This allows the mower to further suppress movement of the grass toward the same side as the rotation direction, and to prevent interference between the auxiliary partition member and the cutter blade.

### Configuration 10

The mower according to Configuration 8 or 9, in which the blade accommodating section includes an upper wall section and a peripheral wall section, an upper edge part of the auxiliary partition member is fixed to a lower surface of the upper wall section, a front end part of the auxiliary partition member is fixed to a wall surface of the peripheral wall section, and a rear end part of the auxiliary partition member is not fixed to the peripheral wall section.

This allows the mower to have the auxiliary partition member made stronger.

### Configuration 11

The mower according to any one of Configurations 8 to 10, in which the peripheral wall section includes: a front-half peripheral wall; and a rear-half peripheral wall, the front-half peripheral wall is formed forward of rotation paths of the cutter blades to be spaced apart from the rotation paths of the cutter blades by a predetermined interval so as to form a grass dropping space, and the auxiliary partition member is located within the grass dropping space.

This causes the turfgrass blocked by the auxiliary partition member to be dropped from the grass dropping space.

### Configuration 12

The mower according to any one of Configurations 1 to 11, in which the cutter blades each include a wing section that generates an updraft.

This allows the mower to efficiently cut turfgrass with the cutter blade.

It goes without saying that the present invention is not limited to the disclosure described above, and can take various configurations without departing from the gist of the present invention.

### REFERENCE SIGNS LIST

10 lawn mower (mower)
11 front wheel
12 cutter blade
13 rear wheel
30 blade accommodating section
31 upper wall section
31A one end
31B the other end
32 peripheral wall section
33 front-half peripheral wall
34 rear-half peripheral wall
38 rectangular peripheral wall
41 first cutter motor
42 second cutter motor
43 third cutter motor
51 partition member
51A upper edge part
51B opposing end parts
52 cutout
58 auxiliary partition member
61 grass catch member
62 lateral inclined surface
63 end inclined surface
64 lower end
121 first cutter blade
122 second cutter blade
123 third cutter blade
S grass dropping space

What is claimed is:

1. A mower comprising:
a plurality of wheels;
at least one cutter blade that cuts turfgrass; and
a blade accommodating section that accommodates the cutter blade, wherein
the blade accommodating section includes an upper wall section and a peripheral wall section, and
the peripheral wall section has an inside accommodating three or more of the cutter blades side by side, the cutter blades rotating in the same direction, a partition member is provided between the two cutter blades accommodated in one end side of the upper wall section, and the partition member is not provided between the cutter blades accommodated in another end side of the upper wall section.

2. The mower according to claim 1, wherein the partition member includes a cutout in a rear end part in a traveling direction, the cutout causing the two cutter blades accommodated in the one end side to communicate.

3. The mower according to claim 2, wherein the cutout is located further rear than half of the partition member.

4. The mower according to claim 2, wherein at least a part of the cutout is located forward of a rotation center of the cutter blade located in the one end side out of the two cutter blades accommodated in the one end side.

5. The mower according to claim 1, wherein the partition member is disposed near the cutter blade located in the other end side out of the two cutter blades accommodated in the one end side.

6. The mower according to claim 1, wherein a part of the partition member is formed low not to overlap a rotation path of the cutter blade, the part of the partition member being to overlap the rotation path without being formed low.

7. The mower according to claim 1, wherein the blade accommodating section includes an upper wall section and a peripheral wall section, and an upper edge part of the partition member is fixed to a lower surface of the upper wall section, and opposing end parts of the partition member are respectively fixed to opposing wall surfaces of the peripheral wall section.

8. The mower according to claim 1, further comprising an auxiliary partition member between the cutter blades accommodated in the other end side so as not to overlap rotation paths of the cutter blades.

9. The mower according to claim 8, wherein a rear end part of the auxiliary partition member is located forward of a rotation center of the at least one cutter blade.

10. The mower according to claim 8, wherein
the blade accommodating section includes an upper wall section and a peripheral wall section,
an upper edge part of the auxiliary partition member is fixed to a lower surface of the upper wall section,
a front end part of the auxiliary partition member is fixed to a wall surface of the peripheral wall section, and
a rear end part of the auxiliary partition member is not fixed to the peripheral wall section.

11. The mower according to claim 8, wherein
the peripheral wall section includes:
a front-half peripheral wall; and
a rear-half peripheral wall,
the front-half peripheral wall is formed forward of rotation paths of the cutter blades to be spaced apart from the rotation paths of the cutter blades by predetermined intervals so as to form a grass dropping space, and
the auxiliary partition member is located within the grass dropping space.

12. The mower according to claim 1, wherein the cutter blades each includes a wing section that generates an updraft.
